(19) United States
(12) Patent Application Publication
(10) Pub. No.: US 2002/0125719 A1
(43) Pub. Date: Sep. 12, 2002

(54) Pipe element for bending pipe sections

(75) Inventor: Harald Timm, Karlsruhe (DE)

Correspondence Address: Lichti, Lempert, & Lasch, Bergwaldstr. 1, Karlsruhe, D-76227, DE

(73) Assignee: IWKA Balg-und Kompensatoren-Technologie GmbH, Stutensee (DE)

(21) Appl. No.: 10/029,925

(22) Filed: Dec. 31, 2001

(30) Foreign Application Priority Data
Jan. 5, 2001 (DE) 201 00 160.8

(51) Int. Cl. F16L 21/00

(52) U.S. Cl. 285/226

(57) ABSTRACT

A bending metal pipe element for bending pipe sections, in particular for return pipes in combustion engines of automobiles, comprising undulations which are disposed one behind the other in the longitudinal direction of the pipe element, is characterized in that the undulations have different outer diameters and undulations having the same outer diameter are disposed in alternating pairs.

This application claims Paris Convention priority of DE 201 00 160.8 filed Jan. 05, 2001 the complete disclosure of which is hereby incorporated by reference.

### BACKGROUND OF THE INVENTION

The invention concerns a bending pipe element of metal for bending pipe sections, in particular for return pipes in combustion engines of automobiles, having sequential undulations in the longitudinal direction of the pipe element. The invention concerns, in particular, pipe elements for return pipes in the form of oil, fuel or exhaust gas pipes of automobile engines.

To ensure simple bending of the pipes, the pipe sections provided for bending are conventionally equipped with undulations provided in the longitudinal direction to permit bending of these pipe sections at the desired angle with little force. If the periodically disposed undulations have relatively large, equal diameters, the bending angle of the overall pipe element is limited to that angle at which the undulations abut on the side (inner side) of the pipe element facing the center of the bending angle. If the undulations have equal, relatively small diameters, bending of the pipe produces over-extensions on the side (outer side) of the pipe element facing away from the center of the bending angle. These pipe sections are therefore generally unsuitable wherever sharp pipe bends are required to save space, e.g. for return pipes installed in the engine compartment of automobiles.

It is therefore the underlying purpose of the present invention to further develop a pipe element of the above-mentioned type to ensure the largest possible bending angle of the pipe without over-extending the pipe material and thereby reliably preventing any damage.

### SUMMARY OF THE INVENTION

In accordance with the invention, this object is achieved by a pipe element of the above-mentioned type in that the undulations have different outer diameters with undulations having the same outer diameter being disposed in alternating pairs.

Compared to prior art, the inventive design of the pipe element permits considerably smaller bending angles with reduced force. At a maximum possible bending angle of the pipe element on the side facing the center of the bending angle, the undulations having a large diameter abut the undulations having a small diameter thereby receiving the latter between them while, on the side of the pipe element facing away from the center of the bending angle, the undulations having large and small diameters are merely extended without complete elimination of their wavy shape.

In a preferred embodiment, the large outer diameter of the undulations exceeds the small outer diameter of the undulations by 5 to 20%, in particular 10 to 15% relative to the smaller outer diameter. In a further preferred embodiment, the undulations of the unbent pipe element have approximately the shape of a segment of a circle, wherein the undulations having a large outer diameter and the undulations having a small outer diameter preferably have approximately the same inner and outer radius. This permits the largest flexibility with respect to stretching and compression thereby preventing failure of the pipe material even with very small bending angles.

The inner radius and the outer radius of both the undulations having a large outer diameter and the undulations having a small outer diameter of the unbent pipe element describe a circular arc of between 175° and 230°.

The inner and the outer radius of all undulations preferably describe a circular path of approximately 180°.

In a preferred embodiment, the unbent pipe element comprises straight sections between the inner and outer radii of the approximately circular segment shaped undulation. This ensures a smooth transition between the convex outer radius and the concave inner radius of neighboring undulations during bending of the pipe element, and, in particular, reliable accommodation of the undulations having a small outer radius between the undulations having a large outer radius on the side facing the center of the bending angle of the pipe element.

The inventive pipe element preferably comprises substantially cylindrical connecting ends without undulations, wherein, in particular, the average outer diameter of the undulations exceeds the outer diameter of the connecting ends by 10% to 35%, relative to the outer diameter of the connecting ends.

The wall thickness of the pipe element is preferably between 0.2 mm and 05. mm, in particular approximately 0.4 mm, at least in the undulating region.

A preferred embodiment of the invention is described in more detail below with reference to the drawing.

### BRIEF DESCRIPTION OF THE DRAWING

FIG. 1 shows a schematic side view of a bending pipe element; and

FIG. 2 shows a schematic detailed view of the undulations of the unbent pipe element in accordance with FIG. 1.

### DESCRIPTION OF THE PREFERRED EMBODIMENT

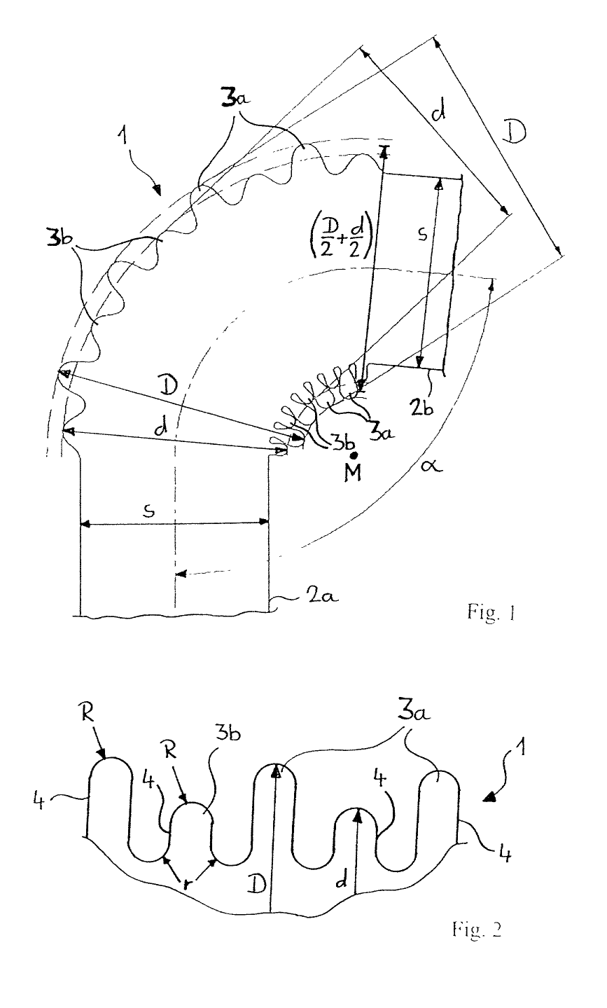

FIG. 1 shows an embodiment of an inventive pipe element 1 in the bent state. The ends of the pipe element 1 (broken off in the drawing) have cylindrical connecting ends 2a, 2b and its central section is provided with undulations 3a, 3b which are disposed in the longitudinal direction and have different outer diameters D, d. Undulations 3a, 3b having the same outer diameter D, d are disposed in alternating pairs. In the embodiment shown, the large outer diameter D of the undulations 3 a exceeds the small outer diameter d of the undulations 3b by approximately 13% relative to the smaller diameter d. The average diameter (D/2+d/2) of the undulations 3a,3b exceeds the outer diameter s of the connecting ends 2a, 2b e.g. by approximately 28, relative to the outer diameter s of the connecting ends 2a, 2b.

As shown in FIG. 2, the undulations 3a, 3b of the unbent pipe element 1 have the shape of the segment of a circle. Both the undulations 3a having a large diameter D and the undulations 3b having a small diameter d have the same inner radius r and outer radius R, which, in the embodiment shown, describe the shape of a circular arc of approximately 180°. Straight sections 4 are disposed between the circular segment shaped crests and troughs of the undulations 3a, 3b.

As shown in FIG. 1, the inventive pipe element 1 permits formation of a very small bending angle a in that, on the side of the pipe element 1 facing the center M of the bending angle α, the undulations 3a having a large diameter D abut the undulations 3b having a small diameter d thereby reliably receiving the latter between them. On the side of the pipe element facing away from the center M of the bending angle α, the undulations 3a having a large diameter D and also the undulations 3b having a small diameter are extended while maintaining an undulating shape.

Due to its high bending capacity requiring little force, the inventive pipe element 1 is particularly suited for pipes disposed in the engine compartment of automobiles, and can be individually adjusted to the usually very small desired bending angles.

List of Reference Numerals

| | |
|---|---|
| 1 | Pipe element |
| 2a, 2b | connecting ends |
| 3a, 3b | undulations |
| 4 | straight section |
| D, d | outer diameter of the undulations |
| D/2, d/2 | average outer diameter of the undulations |
| s | outer diameter of the connecting ends |
| R | outer radius of the undulations |
| r | inner radius of the undulations |
| M | center of the bending angle |
| α | bending angle |

1. A bending pipe element made of metal for bending pipe sections and for return pipes in internal combustion automobile engines, the pipe element comprising:
a first set of undulations having a first outer diameter; and
a second set of undulations having a second outer diameter different than said first outer diameter, said first and said second sets of undulations being disposed one behind the other in a longitudinal direction of the pipe element, wherein said second set of undulations is interposed between neighboring pairs of said first set of undulations and said first set of undulations is interposed between neighboring pairs of said second set of undulations.

2. The pipe element of claim 1, wherein said first outer diameter of said first set of undulations exceeds said second outer diameter of said second set of undulations by 5 to 20%, relative to said second outer diameter.

3. The pipe element of claim 1, wherein said first outer diameter exceeds said second outer diameter by 10% to 15%, relative to said second outer diameter.

4. The pipe element of claim 1, wherein said first undulations of the unbent pipe element have an approximately same circular-segment shape.

5. The pipe element of claim 4, wherein said second set of undulations of the unbent pipe element have said approximately same circular-segment shape.

6. The pipe element of claim 4, wherein said first set and said second set of undulations have an approximately equal inner and outer radius.

7. The pipe element of claim 4, wherein, in the unbent pipe element, an inner radius and an outer radius of said first and said second set of undulations describe circular arcs of between 175° to 230°.

8. The pipe element of claim 4, wherein, in the unbent pipe element, an inner radius and an outer radius of said first and said second set of undulations describe a circular arc of approximately 180°.

9. The pipe element of claim 4, wherein straight sections are disposed in the unbent pipe element between the inner and outer radius of said approximately circular-segment shaped first and second sets of undulations.

10. The pipe element of claim 1, further comprising substantially cylindrical, non-undulated connecting ends.

11. The pipe element of claim 10, wherein an average outer diameter of said first and said second sets of undulations exceeds an outer diameter of said connecting ends by 10% to 35%, relative to said outer diameter of said connecting ends.

12. The pipe element of claim 1, wherein said first and said second sets of undulations are fashioned from a wall thickness of between 0.2 mm and 0.5 mm.

13. The pipe element of claim 1, wherein said first and said second sets of undulations are fashioned from a wall thickness of approximately 0.4 mm.
